(19) United States
(12) Patent Application Publication
(10) Pub. No.: US 2010/0058424 A1
(43) Pub. Date: Mar. 4, 2010

(54) SYSTEM AND METHOD FOR CONTROLLING SIGNAL TRAFFIC PEAKS ON A VIDEO INTERACTIVE NETWORK

(75) Inventor: Amit Garg, Delran, NJ (US)

Correspondence Address: BANNER & WITCOFF , LTD;ATTORNEYS FOR CLIENT NUMBER 007412, 1100 13th STREET, N.W., SUITE 1200, WASHINGTON, DC, 20005-4051, US

(73) Assignee: COMCAST CABLE HOLDINGS, LLC, Philadelphia, PA (US)

(21) Appl. No.: 12/198,230

(22) Filed: Aug. 26, 2008

(51) Int. Cl. H04N 7/173

(52) U.S. Cl. 725/131

(57) ABSTRACT

A system and method for controlling the transmission of signals within an interactive network which transmits audio/visual (A/V) information on at least one channel to a user and including a transmission source configured to transmit the A/V information on the at least one channel is provided. The system includes at least one set-top box and at least one random number generator. The set-top box is configured to record the A/V information on a channel at a predetermined recording time and to transmit a change channel request signal to the transmission source prior to the predetermined recording time to change the channel to record the A/V information at the predetermined recording time. The random number generator is configured to generate a time value such that the at least one set-top box transmits the change channel request signal to the transmission source at the time value prior to the predetermined recording time.

### BACKGROUND

1. Technical Field

The embodiments of the invention described herein generally relate to a system and method for controlling signal traffic peaks on a video interactive network.

2. Background Art

A set-top box is generally defined as a device that receives an RF signal that corresponds to audio/video (A/V) data from a cable provider. The set-top box is also capable of receiving digital signals in a data network. A display device e.g., a television is operably coupled to the set-top box and receives the RF signal to visually and/or audibly playback the A/V data for a user. Set-top boxes are known to include a high capacity memory device, e.g., a hard drive embedded within to record the A/V video data. Such set-top boxes are known as digital video recorders (DVRs) or personal video recorders (PVRs).

DVRs have become quite popular and are used by a large number of television consumers. It is not uncommon for a large group of consumers to set their corresponding DVR to record a particular show at a particular time. With the transition of technologies from Broadcast to Switched Networks, not all A/V data is carried at all times. Switched Networks are known to transit the A/V data on a channel that is desired to be viewed by the consumer at a particular time (e.g., Switch Digital Video (SDV) networks are generally not configured to transmit A/V data on all channels all of the time). Thus, a set-top box transmits a change channel request signal within the network for a particular channel to be added (e.g., transmit A/V data on the particular channel). In the event a large group of cable consumers intend to record a popular program, such a situation may result in a barrage of change channel request signals that are transmitted from the corresponding set-top boxes to an application server at the same time (i.e., at the start record time). The application server is generally coupled between a transmission source and a modulator. The application server adds the channel with the desired A/V data that is to be viewed or recorded to the modulator and sends the set-top box a message indicating the location of the channel in response to the change channel request signal.

In the event a large group of consumers desire to record the same program that begins at the same time, such a condition may lead to increased contention. The barrage of change channel request signals may downgrade performance of the video network. In general, if two or more set-top boxes each transmit a change channel request signal at the same time, such a condition may cause the change channel request signals to collide. Due to the collisions, the set-top boxes may back off for a predetermined amount of time and attempt to retransmit the change channel request signal at a later time. Increased collisions may prevent the transmission source from transmitting the desired A/V data on the desired channel at the desired recording time or for the set-top box to tune to the desired A/V channel.

Conventionally, cable providers generally add more bandwidth by adding more demodulators within the network to facilitate communication between the set-top boxes and the application server in an attempt to compensate or to avoid potential collisions in the network. The addition of demodulators in the video network may add significant cost to the overall video network. There is also physical limit to the number of demodulators that can be added to a video network due to a limited upstream frequency spectrum available in the network.

### BRIEF DESCRIPTION OF THE DRAWINGS

The embodiments of the present invention described herein are recited with particularity in the appended claims. However, other features will become more apparent and the embodiments of the present invention may be best understood by referring to the following detailed description in conjunction with the accompany drawings in which:

FIG. 1 depicts a video interactive network in accordance to one embodiment of the present invention; and

FIG. 2 depicts a method for controlling signal traffic peaks on the network of FIG. 1 in accordance to one embodiment of the present invention.

### DETAILED DESCRIPTION

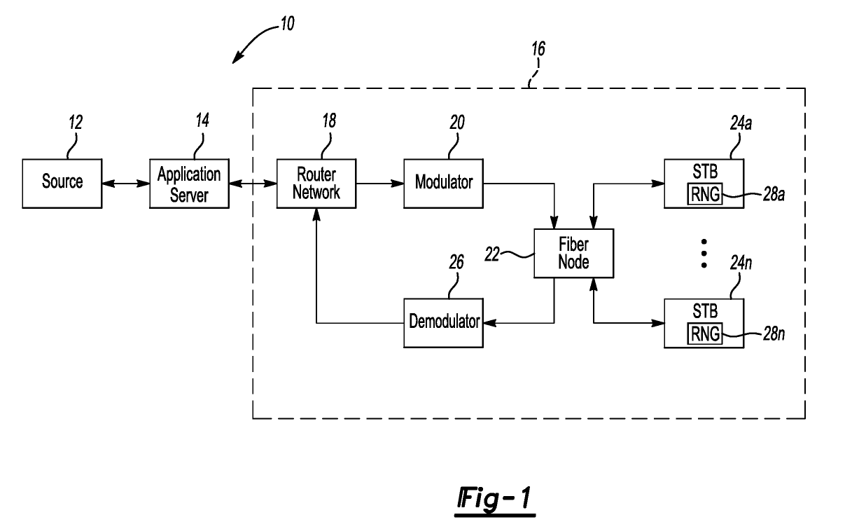

FIG. 1 depicts a video interactive network 10 in accordance to one embodiment of the present invention. The network 10 generally comprises a transmission source 12, an application server 14 and a sub-network 16 and routes the audio/video (A/V) information (e.g., A/V data stream or radio frequency (RF) based A/V signal) therein. The transmission source 12 is adapted to generate the A/V data stream. The A/V data stream comprises a plurality of packets. Each packet may include video and/or audio data. In general, the network 10 may be implemented as part of an SDV environment as described above. In addition, the network 10 may be implemented in a video on demand (VoD) network or any other such network environment that utilizes interactive signal traffic between the application server 14 and the sub-network 16.

The transmission source 12 transmits the A/V data stream to the application server 14. In general, the application server 14 manages the flow of A/V data stream between the sub-network 16 and other such sub-networks (not shown) that are configured to receive the A/V data stream. It is contemplated that a plurality of sub-networks may be coupled to the application server 14. The application server 14 routes or controls the A/V data stream to one or more of the plurality of sub-networks. In general, the application server 14 may be comprised of multiple building blocks that may each serve as a unique server that provides partial functionality.

The sub-network 16 generally comprises a router network 18, a modulator 20, a plurality of set-top boxes 24a-24n and a demodulator 26. It is generally contemplated that the sub-network 16 may include any number of router networks, modulators, and demodulators. The particular number of router networks, modulators, and demodulators implemented within the sub-network 16 may vary based on the desired criteria of a particular implementation.

In general, the application server 14 may route the A/V data stream downstream within the sub-network 16 so that each set-top box 24a-24n is configured to interface with a display device (e.g., a television) to play back the A/V data within the stream for a user. The application server 14 transmits the A/V data stream in the form of audio and/or video packets to the router network 18. The application server 14 also transmits channel message signals into the sub-network 16. The channel message signals provide location information with respect to where the set-top box 24a-24n can locate a channel to display the desired A/V data. Such information within the channel message signals are in the form of digital packets. The router network 18 receives and transmits the A/V data stream and the channel message signals to the modulator 20. The router network 18 may transmit the A/V data stream to additional modulators (not shown) in the event such modulators were included within the sub-network 16. Likewise, the router network 18 may also transmit the A/V data stream and channel message signals to other such router networks (not shown) in the event such router networks were included within the sub-network 16. These router networks may transmit the A/V data stream and the channel message signals to additional modulators (not shown) in the sub-network 16.

The modulator 20 receives the A/V data stream while in packet form from the router network 18 and converts the packets into the RF based A/V signal. In addition, the modulator 20 receives the channel message signals and connects the packets therein into RF based channel message instructions. The modulator 20 transmits the RF based A/V signal and the RF based channel message instructions to the fiber node 22. The fiber node 22 is configured to transmit the RF A/V signal and RF channel message instructions via coaxial cable (or other twisted pair wire configuration) to one or more of the plurality of set-top boxes 24a-24n. The set-top boxes 24a-24n receive the RF channel message instructions which provide location information with respect to where the desired channel is located. The set-top boxes 24a-24n locates the desired channel location in response to the RF channel message instructions to display the RF A/V signal at the desired channel.

Each set-top box 24a-24n may include a high capacity hard drive (or other such storage mechanism generally situated for implementation as a DVR or PVR) for the purpose of storing (or saving) the A/V data thereon. Each set-top box 24a-24 generally includes a controller (not shown) having code programmed therewith to interface with a user interface so that a user can program the set-top box 24a-24n to record a desired program from a particular channel at a particular time in response to manipulating the user interface. In one example, the user interface includes switches positioned on each set-top box 24a-24n to facilitate touch selection to record the desired program at a particular start record time. In yet another example, the user interface includes a remote controller to facilitate remote touch selection to record the desired program from the particular channel at the particular time.

In general, each set-top box 24a-24n is configured to generate a change channel request signal prior to recording data. The set-top boxes 24a-24n generates and modulates the change channel request signal as an RF based signal. Each set-top box 24a-24n transmits the change request signal to the fiber node 22 via coax cables. The fiber node 22 transmits the change request signal to the demodulator 26. The demodulator 26 converts the change request signal from an RF based signal into a packet based data signal. The router network 18 routes the change request data signal to the application server 14. The application server 14 transmits the A/V data stream and the channel message signals (e.g., to indicate the location of the A/V data stream). The implementation of the coax cables, transmission of the change request signal to the application server 14 and the transmission of the A/V data on the desired channel and channel message signals prior to the start record time generally corresponds to an exemplary embodiment and that other such implementations are contemplated.

The set-top boxes 24a-24n generally include random number generators 28a-28n, respectively. In general, the set-top box 24a-24n utilizes the random number generators 28a-28n such that each set-top box 24a-24n transmits the change channel request through the sub-network 16 back to the application server 14 at different times from one another based on the random number generated within each corresponding set-top box 24a-24n. For example, any such random number generated corresponds to a time offset value for transmitting the change channel request signal. The transmission of the change channel request signals at different times from one another may optimize signal traffic peaks within the network 10 and may reduce the potential for signal collisions to occur.

For example, assuming that the set-top boxes 24a-24n comprise a total of ten set-top boxes, in such a case, a first set-top box transmits the change channel request signal one second before the actual start time of the recording. In such an example, a step function of 100 milliseconds (msec) is implemented such that the nine remaining set-top boxes transmit the change channel request signal 100 msec from one another. In such a case, the signal traffic peak over the network 10 are distributed over 10 points in time. Such a distribution minimizes signal traffic through the network 10 and reduces the likelihood of signal collisions thereby increasing signal throughput. The implementation of the random number generators within the set-top boxes 24a-24n and the capability of generating the change channel request signals at different times from one another provides for the same level of gain as that accomplished by coupling ten demodulators to the ten set-top boxes. In general, the amount of time in which the various set-top boxes 24a-24n transmit the change channel request from one another other varies based on the desired criteria of a particular implementation.

In general, each random number generator 28a-28n is configured to generate a different random number from one another. To ensure that each random number generator 28a-28n generates a random number that is different from one another, each random number generator 28a-28n may use a different initial seed value from one another.

In one example, the initial seed value comprises a manufacturer code or serial number that is specific for each set-top box 24a-24n. The manufacturing code or serial number corresponds to a unique combination of digits and/or letters. In yet another example, the initial seed value comprises a media access control (MAC) address (or other quasi-unique identifier) for each set-top box 24a-24n. The MAC address generally corresponds to a universally administered address that is uniquely assigned to a network card (or built-in network adapter) positioned within each set-top box 24a-24n by a respective manufacturer. In this case, the particular manufacturer of the set-top box 24a-24n assigns the MAC address to establish the initial seed value for the random number generators 28a-28n. By configuring the initial seed values such that the seed values for each random number generator 28a-28n is unique, such a condition ensures that the random number generators 28a-28n generate different numbers (or time offset values) from one another in the event the set-top boxes 24a-24n initialize at the same time after a power outage condition.

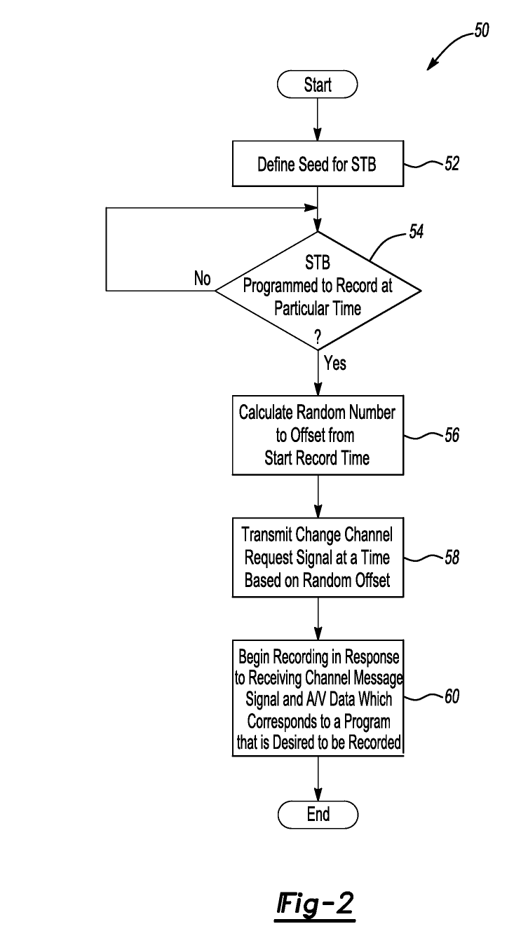

FIG. 2 depicts a method 50 for controlling traffic peaks on the network of FIG. 1 in accordance to one embodiment of the present invention.

In block 52, a different seed value is defined for each set-top box 24a-24n. As noted above, it is generally contemplated that each seed value is unique to ensure that the random numbers sequence generated by the random number generators 28a-28n are different from one another. The seed value may be defined and stored in memory of each set-top box 24a-24n during the assembly, production, or initialization or set-up of the set-top boxes 24a-24n by a particular set-top box manufacturer.

In block 54, a determination is made as to whether a user has programmed the one or more set-top boxes 24a-24n to record a particular program at a particular channel and time. The channels may be the same or correspond to different channels from one another if multiple set-top boxes 24a-24n are programmed to record the A/V data at the same start record time. In the event the user has not programmed one or more of the set-top boxes 24a-24n, the method 50 remains in block 54. In the event the user has programmed one or more set-top boxes 24a-24n, the method 50 moves to block 56.

In block 56, the set-top box 24a-24n calculates the random number based on the initial seed value stored in memory. Such an operation is performed the first time the set-top box 24a-24n is programmed to record the desired program (e.g., after set-top box 24a-24n installation). Further, in the event the set-top boxes 24a-24n are calculating the random number for the first time after a power loss (or outage) condition, the set-top boxes 24a-24n may use the corresponding initial seed value stored therein to calculate the random number. After the set-top box 24a-24n generates the first random number with the initial seed value, the set-top box 24a-24n may use any of a multitude of random number algorithms for the subsequent number. In one example, the set-top box 24a-24n utilizes an internal real-time clock or other such suitable value capable of being provided by the controller in each set-top box for insertion into the random number generator 28a-28n as a secondary seed value. Since the initial seed values used between the set-top boxes 24a-24n are different from one another, subsequent random numbers used thereafter (even if similar) may be sufficient for the random number generators 28a-28n to produce numbers that are different from one another. It is generally contemplated that the internal real-time clock may be used as an initial seed value or as a secondary seed value.

In block 58, the set-top box 24a-24n transmits the change channel request signal based on the number generated by the random number generator 28a-28n. For example, in the event the set-top box 24a-24n calculates a number (or value) of 50 ms, the set-top box 24a-24n transmits the change channel request signal 50 ms before the start record time. The set-top box 24a-24n transmits the change channel request signal through the sub-network 16 to the application server 14.

In block 60, application server 14 transmits the A/V data stream which corresponds to the desired channel as indicated on the change channel request signal prior to the start record time as programmed to the set-top box 24a-24n. The application server 14 also transmits the channel message signal prior to the start record time to indicate the location of the channel which transmits the A/V data stream. The set-top box 24a-24n utilize the channel message signal to locate the channel that provides the desired A/V data. The sub-network 16 modulates the A/V data stream to the RF A/V signal and the channel message signal to the RF channel location instructions prior to delivery to the set-top boxes 54a-54n. The set-top boxes 24a-24n locate the channel of the RF A/V signal based on the RF channel message instructions and begin recording data on the RF A/V signal at the start record time.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for controlling the transmission of signals within an interactive network which transmits audio/visual (A/V) information to a user and including a transmission source configured to transmit the A/V information on at least one channel and an application server configured to control the flow of the A/V information into the network, the system comprising:
at least one set-top box configured to:
receive the A/V information on a channel;
record the A/V information on the channel at a predetermined recording time; and
transmit a change channel request signal to the application server prior to the predetermined recording time to enable recording the A/V information at the predetermined recording time on the channel; and
at least one random number generator configured to generate a time offset value such that the at least one set-top box transmits the change channel request signal to the application server at the time offset value prior to the predetermined recording time.

2. The system of claim 1 wherein the at least one set-top box is further configured to store at least one preselected initial seed value.

3. The system of claim 2 wherein the at least one random number generator is further configured to receive the at least one preselected initial seed value from the at least one set-top box and to generate the time offset value based upon the at least one preselected initial seed value.

4. The system of claim 3 wherein the at least one set-top box is further configured to transmit the at least one preselected initial seed value after a power reset condition.

5. The system of claim 2 wherein the at least one preselected initial seed value corresponds to a media access control (MAC) address that is specific to a particular set-top box.

6. The system of claim 2 wherein the at least one preselected initial seed value corresponds to a serial number that is specific to a particular set-top box.

7. A system for controlling the transmission of signals within an interactive network which transmits audio/visual (A/V) information a user and including a transmission source configured to transmit the A/V information on at least one channel and an application server configured to control the flow of the A/V information into the network, the system comprising:
a first set-top box configured to transmit a first change channel request signal for instructing the application server to change to a channel and to record the A/V information on the channel at the predetermined recording time; and
a second set-top box configured to transmit a second change channel request signal for instructing the application server to change to the channel and to record the A/V information on the channel at the predetermined recording time; and
wherein the first set-top box is further configured to transmit the first change channel request signal to the application server at a first time offset value prior to the predetermined recording time and the second set-top box is further configured to transmit the second change channel request signal to the application server at a second time offset value prior to the predetermined recording time, the second time offset value being different than the first time offset value.

8. The system of claim 7 further comprising first and second random number generators configured to generate the first and the second time offset values, respectively.

9. The system of claim 8 wherein the first and the second set-top boxes are further configured to store first and second preselected initial seed values, respectively and to transmit the first and the second preselected initial seed values to the first and the second random number generators, respectively for generating the first and the second time offset values, respectively.

10. The system of claim 9 wherein the first and the second preselected initial seed values are different from one another.

11. The system of claim 10 wherein the first random number generator is further configured to generate the first time offset value with the first preselected initial seed value after a power reset condition and the second random number generator is further configured to generate the second time offset value with the second preselected initial seed value after a power reset condition.

12. The system of claim 9 wherein the first preselected initial seed value corresponds to a first media access control (MAC) address that is specific to the first set-top box and the second preselected initial seed value corresponds to a second MAC address that is specific to the second set-top box.

13. The system of claim 9 wherein the first preselected initial seed value corresponds to a first serial number of the first set-top box and the second preselected initial seed value corresponds to a second serial number of the second set-top box.

14. A method for controlling the transmission of signals within an interactive network including a transmission source for transmitting audio/visual (A/V) information on at least one channel to a user and an application server for directing the flow of the A/V information into the network, the method comprising:
receiving the A/V information on a first channel from the application server;
recording the A/V information on a second channel at a predetermined recording time;
transmitting a first change channel request signal at a first time offset value and a second change channel request signal at a second time offset value prior to the predetermined recording time for instructing the application server to change channels from the first channel to the second channel to enable recording the A/V information at the predetermined recording time; and
randomly generating the first time offset value via a first random number generator and the second time offset value via a second random number generator.

15. The method of claim 14 wherein the first and the second time offset values are different from one another.

16. The method of claim 14 further comprising inserting a first preselected initial seed value into the first random number generator prior to randomly generating the first time offset value and inserting a second preselected initial seed value into the second random number generator prior to randomly generating the second time offset value.

17. The method of claim 16 further comprising inserting any random seed value into the first and the second random number generators after inserting the first and the second preselected initial seed values.

18. The method of claim 16 wherein the first preselected initial seed value corresponds to a first media access control (MAC) address of a first set-top box and the second preselected initial seed value corresponds to a second media access control (MAC) address of a second set-top box.

19. The method of claim 16 wherein the first preselected initial seed value corresponds to a first serial number of a first set-top box and the second preselected initial seed value corresponds to a second serial number of a second set-top box.

20. The method of claim 16 further comprising inserting the first preselected initial seed value into the first random number generator in response to detecting a power outage condition and inserting the second preselected initial seed value into the second random number generator in response to detecting a power outage condition.
